(19) United States
(12) Patent Application Publication
(10) Pub. No.: US 2009/0245892 A1
(43) Pub. Date: Oct. 1, 2009

(54) DEVELOPING ROLLER

(75) Inventors: Shinya OBARA, Tokyo (JP); Akira OHIRA, Tokyo (JP); Takeo OSHIBA, Tokyo (JP)

Correspondence Address: CANTOR COLBURN, LLP, 20 Church Street, 22nd Floor, Hartford, CT, 06103, US

(73) Assignee: Konica Minolta Business Technologies, Inc., Tokyo (JP)

(21) Appl. No.: 12/410,969

(22) Filed: Mar. 25, 2009

(30) Foreign Application Priority Data
Mar. 28, 2008 (JP) JP2008-086296

(51) Int. Cl. G03G 15/08

(52) U.S. Cl. 399/286

(57) ABSTRACT

In the present invention, provided can be a developing roller through which neither fog nor contamination inside the apparatus is generated, and no insufficient image density is produced, even though printing a large number of paper sheets (5000 paper sheets, for example). Also disclosed is a developing roller possessing a conductive shaft and a coating layer provided on an outer circumference of the conductive shaft, wherein the coating layer possesses a resin and a surface roughness particle, and the coating layer surface has a surface roughness Ra of 0.5-2.5 μm and a Young's modulus Y of 1-200 MPa.

This application claims priority from Japanese Patent Application No. 2008-086296 filed on Mar. 28, 2008, which is incorporated hereinto by reference.

### TECHNICAL FIELD

The present invention relates to a developing roller, and specifically to a developing roller employed for a non-contact type single-component developing system.

### BACKGROUND

In recent years, the developments of image forming technology of copiers, printers, fax machines and so forth has largely been accelerated, and among these, an image forming apparatus based on an electrophotographic system is frequently utilized. Further, with the performance improvement of technology associated with personal computers, an apparatus capable of forming color images, and a small-sized and lightweight image forming apparatus at low cost have been demanded, whereby further improvement and boosting performance have still been desired.

As the electrophotographic developer employed for the image forming apparatus, there provided are a two-component developer composed of toner and carrier, and a single-component developer composed of nonmagnetic or magnetic toner. Neither stirring device to mix the toner and the carrier, nor controlling step to keep a mixture ratio of the toner and the carrier constant which is provided in a developing device, in which a single-component developer is utilized, is advantageous for the developing device, since no carrier is used.

Further, since no magnet is used for a nonmagnetic single-component developing system employing a nonmagnetic single-component toner, this system is preferably utilized for a smaller size printer at a low price.

Further, among the nonmagnetic single-component developing systems, a non-contact developing system to conduct developing by separately placing a photoreceptor and a developing roller is advantageous to high image quality and colorization.

The spread of printers at low cost has also triggered development of a technique by which a developing roller is installed in a developing cartridge to serve as a function of a developing device, and to achieve downsizing and low cost, whereby attention has been focused on a removable toner cartridge type image forming apparatus.

Further, from growing the recent environmental consciousness, developed has been a developing cartridge of a toner supply system by which a developing device is used multiple times by supplying the toner into the developing device in which a developing roller is installed, besides the cartridge removable type. Because of this, ease of maintenance (longer life of a cartridge) is strongly demanded, and resistance to degradation during repetitive use is desired.

Only recently disclosed is a developing device equipped with a developing roller in which a developing roller subjected to a surface treatment conducted on the surface of a substrate such as a blasting process or the like without providing a conductive elastic layer in order to obtain a developing roller at low cost and in lightweight and downsizing, and only a thin functional layer is provided on the surface of a substrate (refer to Patent Documents 1 and 2, for example).

(Patent Document 1) Japanese Patent O.P.I. Publication No. 2001-66876

(Patent Document 2) Japanese Patent O.P.I. Publication No. 2002-14535

### SUMMARY

However, in cases where a developing roller formed without providing a conductive elastic layer is employed, there appears a problem such that stress is applied to the nonmagnetic single-component toner when forming a thin layer made of the nonmagnetic single-component toner between the developing roller and a regulation blade, and external additives fixed on the nonmagnetic single-component toner surface during printing a large number of paper sheets are embedded in the toner particle, whereby no normal charging amount can be maintained.

When the nonmagnetic single-component toner can not maintain the normal charging amount, there are problems such that fog caused by an insufficient charging amount and contamination inside the apparatus are generated, and insufficient image density caused by conveyance failure is also produced.

It is an object of the present invention to provide a developing roller by which fog and contamination inside the apparatus are not generated, and insufficient image density is not produced, even though printing a large number of paper sheets employing a non-contact single-component developing system image forming apparatus.

### BRIEF DESCRIPTION OF THE DRAWINGS

Embodiments will now be described, by way of example only, with reference to the accompanying drawings which are meant to be exemplary, not limiting, and wherein like elements numbered alike in several figures, in which:

FIGS. 1 (a), 1(b) and 1(c) each show a (cross-sectional) diagram showing an example of a developing roller;

FIG. 2 shows an example of a roughness curve obtained via measurement of surface roughness (Ra);

FIG. 3 is a schematic diagram showing a measuring device of a volume resistance of a coating layer;

FIG. 4 is a cross-sectional schematic view showing an example of a developing device of the present invention; and

FIG. 5 is a schematic cross-sectional view showing an example of a full color image forming apparatus.

### DESCRIPTION OF THE PREFERRED EMBODIMENTS

The above object of the present invention is accomplished by the following structures.

(Structure 1) A developing roller comprising a conductive shaft and a coating layer provided on an outer circumference of the conductive shaft, wherein the coating layer comprises a resin and a surface roughness particle, and the coating layer surface has a surface roughness Ra of 0.5-2.5 μm and a Young's modulus Y of 1-200 MPa.

(Structure 2) The developing roller of Structure 1, comprising a double-layered structure having an upper layer comprising a resin, and a lower layer comprising a resin and a surface roughness particle, provided that the lower layer is located at a nearer position to the conductive shaft than the upper layer.

(Structure 3) The developing roller of Structure 1, wherein the surface roughness particle has a volume-based average median particle diameter D₅₀ of 5-30 μm.

(Structure 4) The developing roller of Structure 1, wherein the surface roughness particle has a volume-based average median particle diameter D₅₀ of 7-20 μm.

(Structure 5) The developing roller of Structure 1, wherein the surface roughness particle comprises a resin particle.

(Structure 6) The developing roller of Structure 1, wherein the coating layer surface has a surface roughness Ra of 0.7-2.0 μm.

(Structure 7) The developing roller of Structure 1, wherein the coating layer surface has a Young's modulus Y of 2-170 MPa.

(Structure 8) The developing roller of Structure 1, wherein the coating layer surface has a Young's modulus Y of 140-170 MPa.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

Attention has been focused on surface roughness of the surface of a coating layer of the developing roller, which has been studied by the inventors in order to solve the above-described problem.

Surface roughness is formed on the surface of the developing roller employed with the non-contact nonmagnetic single-component toner to convey the nonmagnetic single-component toner to a developing section after forming it in the form of a thin layer.

Methods of forming surface roughness of the developing roller surface are as follows.

1. The surface subjected to a sandblasting treatment.
2. The surface roughness particle added to form a coating layer.

In the case of the sandblasting method, it is difficult to form even surface roughness on the developing roller surface, there is a problem such as stability of toner conveyance, and there is also another problem such as reproducibility during preparation.

The method of forming a coating layer via addition of the particle requirement to produce surface roughness is a preferable method to adjust surface roughness since the surface roughness can be arbitrarily formed by an addition amount or a particle diameter of the surface roughness particle.

On the other hand, when the nonmagnetic single-component toner conveyed by a developing roller passes through between a regulation blade and the roller, a thin layer is formed to provide electrification with the regulation blade.

In order to realize evenly provided electrification and conveyance, regulation pressure of the regulation member is desired to be raised at some level.

In the case of a developing roller having no elastic layer and exhibiting high hardness of the developing roller surface, it is difficult to release pressure of the regulation blade, and since force is directly applied to the toner from the regulation blade, external additives attached on the toner surface are embedded inside the toner, resulting in acceleration of lowering in toner electrification characteristics.

In the case of a developing roller having small surface roughness, since conveyance of the nonmagnetic single-component toner is insufficiently conducted, there appears a problem such that the toner amount contributed to the development is small, resulting in insufficient toner image density.

In the case of a developing roller having too large surface roughness, since the nonmagnetic single-component toner tends to be fixed on the developing roller, and filming, by which toner employed as the nonmagnetic single-component toner is fixed on the developing roller, is generated, there appears another problem such that fog and toner scattering are generated to printing images.

After considerable effort during intensive studies, the inventors have found out that when employing a developing roller in which surface roughness of a coating layer provided on the outer circumference of a conductive shaft, and hardness of the surface are identified, conveyance of the toner is specified, and stress applied to the toner is reduced to solve the above-described problems, resulting in accomplishment of the present invention.

A developing roller of the present invention possesses a conductive shaft and a coating layer provided on an outer circumference of the conductive shaft, and the coating layer comprises a resin and a surface roughness particle. The coating layer surface has a surface roughness Ra of 0.5-2.5 μm and a Young's modulus Y of 1-200 MPa.

In the case of the surface roughness of less than 0.5 μm, toner conveyability is lowered, whereby developability is lowered. Further, in the case of the surface roughness exceeding 2.5 μm, stress is to be excessively applied, and degradation of the toner is accelerated during prolonged use, whereby there appears a problem such that toner scattering and fog in addition to degradation in developability are generated.

When Young's modulus of the coating layer surface is less than 1 MPa, deformation of the coating layer tends to be generated, and degradation of the toner is further generated because of no stabilization in toner conveyance, resulting in degradation in developability via prolonged use. Further, in the case of the Young's modulus exceeding 200 Mpa, stress is excessively applied to the toner because of the hard surface layer, whereby there appears another problem such that degradation of the toner is generated during prolonged use of the toner.

It was confirmed that not only generation of fog caused by degradation of the toner and contamination inside the apparatus, but also generation of insufficient image density caused by conveyance failure of the toner could be inhibited by employing a developing roller possessing surface roughness Ra of the above-described coating layer surface and Young's modulus Y of the coating layer surface.

Next, the present invention will be now described in detail

### <<Developing Roller>>

The developing roller of the present invention is a developing roller possessing a coating layer containing a resin and surface roughness particles with no elastic layer provided on the outer circumference of a conductive shaft. The layer structure of the coating layer is not specifically limited. A single layer structure may be allowed, and a double-layered structure having an upper layer and a lower layer may also be allowed, but the double-layered structure is preferable in view of a layer structure exhibiting excellent adhesion to the conductive shaft and excellent durability.

The developing roller having a double-layered structure may possess an upper layer formed by coating a resin solution, which is provided on a lower layer formed by coating a coating solution in which surface roughness particles are dispersed in a resin solution.

### <Layer Structure>

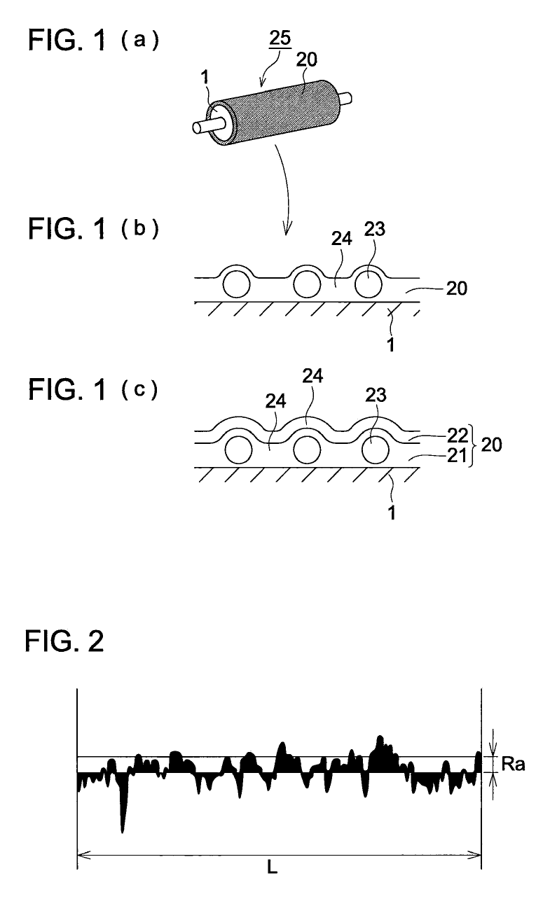

FIGS. 1 (a), 1(b) and 1(c) each show a (cross-sectional) diagram showing an example of a developing roller.

In FIGS. 1 (a), 1(b) and 1(c), numeral 25 represents a developing roller, numeral 1 represents a conductive shaft, numeral 20 represents a coating layer, numeral 22 represents an upper layer, numeral 21 represents a lower layer, numeral 23 represents a course particle, and numeral 24 represents a resin.

FIG. 1 (a) shows an appearance diagram of a developing roller. FIG. 1(b) shows developing roller 25 possessing conductive shaft 1 and coating layer 20 containing resin 24 and particle 23 provided on the outer circumference of the conductive shaft. FIG. 1(c) shows a developing roller wherein provided is a coating layer 20 composed of lower layer 21 containing resin 24 and surface roughness particle 23 provided on the outer circumference of conductive shaft 1, and upper layer 22 containing resin 24, indicating that particle 23 is present in the lower layer.

The coating layer preferably has a layer thickness of 5-μm. In the case of a double-layered structure, the lower layer preferably has a layer thickness of 5-20 μm, and the upper layer preferably has a layer thickness of 2-10 μm.

### (Surface Roughness)

The coating layer surface of the developing roller has a surface roughness Ra of 0.5-2.5 μm, and preferably has a surface roughness Ra of 0.7-2.0 μm.

An appropriate amount of toner can be conveyed to a developing section, and degradation of toner can be inhibited by falling surface roughness Ra of the coating layer surface within the above-described range.

Surface roughness Ra of the developing roller can be adjusted by the diameter of the surface roughness particle added when forming the coating layer.

In order to prepare a developing roller having surface roughness Ra specified in the present invention, surface roughness particles having a volume-based median particle diameter D₅₀ of 5-30 μm are preferably usable.

### (Measurement of Surface Roughness Ra)

Surface roughness Ra is a mean value obtained via summation of the absolute value of the deviation up to the measured curve from the center-line of the extracted part, after measuring a roughness curve as shown in FIG. 2, and extracting reference length L in the direction of its center-line from the roughness curve, employing the following formula.

$$Ra = \frac{1}{L} {\int }_{0}^{L} \vert f ( x ) \vert d x$$

FIG. 2 shows an example of a roughness curve obtained via measurement of surface roughness (Ra).

Surface roughness (Ra) is measured under the following conditions employing a surface roughness meter “SURFCOM 1400D” manufactured by Tokyo Seimitsu Co., Ltd.

Specifically, 10 points are randomly measured under the following condition, and the mean value is designated as surface roughness Ra.

In addition, there is usable any apparatus giving rise to the same result falling within an error range.

### Measurement Conditions

Measurement length L: 4.0 mm

Reference length Lr: 0.8 mm

Cut-off wavelength λc: 0.8 mm

Stylus tip shape: a tip angle of 60°, circular cone

Stylus tip radius: 2 μm

Measurement speed: 0.3 mm/sec

Measurement magnification: 10,000 times

Measurement environment: 20° C. and 50% RH

### <Young's Modulus>

Hardness of the coating layer surface of a developing roller is specified by Young's modulus. The coating layer surface has a Young's modulus Y of 1-200 MPa, preferably has a Young's modulus Y of 2-170 MPa, and more preferably has a Young's modulus Y of 140-170 MPa.

Embedding of the toner in the coating layer can be avoided by setting Young's modulus to at least 1 MPa, and stress applied to the toner can be reduced by setting Young's modulus to 200 MPa or less.

Young's modulus of the coating layer can be adjusted by resin kinds and kinds of surface roughness particles usable for coating layer formation, a mixture ratio of the resin to the surface roughness particle, and so forth.

### (Measurement of Young's Modulus Y)

Young's modulus of the coating layer is measured under the following conditions employing a indentation hardness tester H100, manufactured by F. Fischer company.

Specifically, 10 points are randomly measured under the following condition, and the mean value is designated as Young's modulus Y.

In addition, there is usable any apparatus giving rise to the same result falling within an error range.

### Measurement Conditions

Indenter: a diamond indenter having a square pyramid shaped indenter tip having a surface-to-tip angle of 136°

Measurement condition: 2 mN/10 sec

Measurement time: 10 sec

Measurement environment: 20° C. and 50% RH

Next, preparation of a developing roller will be described.

### <<Constituent Material of Developing Roller>>

First, members constituting a developing roller will be described.

### (Preparation of Conductive Shaft)

Since s conductive shaft of the present invention also serves as a member to leak charge stored on the developing roller surface, it is preferably made of conductive metal. Examples of the typical conductive metal include stainless steel (SUS303, for example), iron, aluminum, nickel, an aluminum alloy, a nickel alloy and so forth, which has a diameter of 1-30 mm. Further, the conductive shaft may be made of a conductive resin.

### (Surface Roughness Particle)

The surface roughness particle is utilized so as to fall surface roughness of the developing roller within the range specified in the present invention.

As the particle diameter of the surface roughness particle, the surface roughness particle preferably has a volume-based average median particle diameter D₅₀ of 5-30 μm, and the surface roughness particle more preferably has a volume-based average median particle diameter D₅₀ of 7-20 μm. The surface roughness particle is preferably one in the form of a sphere.

The surface roughness particles are insoluble in a coating solution to form a coating layer. Specific examples thereof include polyamide based resin particles such as crosslinked acrylic resin particles, nylon 6 and so forth; polyolefin based resin particles such as polyethylene, polypropylene and so forth; silicone based resin particles; phenol based resin particles; polyurethane based resin particles; styrene based resin particles; benzoguanamine particles and so forth. Of these, polyethylene resin particles and polyurethane based resin particles are preferable.

### (Resin Components of Coating Layer)

Resin components usable for formation of a coating layer are not specifically limited, as long as specified Young's modulus is obtained, but specific examples thereof include a urea resin, a melamine resin, an alkyd resin, a modified alkyd resin (a phenol modified or silicone modified alkyd resin, for example), an oil-free alkyd resin, acrylic resin, a silicone resin, a fluorine resin, a phenol resin, a polyamide resin, an epoxy resin, a polyester resin, a maleic acid resin, a polyurethane resin, ethylene-vinyl acetate copolymer resin and so forth. Of these, a polyester resin and a polyurethane resin are preferable in view of acquisition of excellent wear resistance and Young's modulus specified in the present invention.

A polyurethane resin can be one obtained by reacting a polyhydroxy compound and an urethane raw material containing an isocyanate compound, and examples thereof include those obtained with a method by which prepolymers are crosslinked or with a method by which polyol is reacted with polyisocyanate employing a one shot technique.

In this case, examples of the polyhydroxyl compound employed during preparation of the urethane resin include; polyols employed to prepare a common soft polyurethane foam or a urethane elastomer, for example, a polyether polyol, a polyester polyol and a polyether polyester polyol, each having a polyhydroxyl group at the terminal. Also usable are common polyols such as: polyolefin polyols, for example, polybutadiene polyol and polyisoprene polyol; and so-called polymer polyol obtained by polymerizing ethylenically unsaturated monomers in a polyol. In addition, examples of the isocyanate include: polyisocyanates used for manufacturing common soft polyurethane foam and urethane elastomers such as: toluene diisocyanate (referred to also as TDI), crude TDI, 4,4′-diphenyl methane diisocyanate (referred to also as MDI), crude MDI, aliphatic polyisocyanate having 2-18 carbon atoms, alicyclic polyisocyanate having 4-15 carbon atoms, mixtures of the above polyisocyanates and modified isocyanate compounds thereof, for example, prepolymers obtained by partially reacted with a polyol. In particular, in order to reduce the universal hardness of the coating layer, the mixing ratio of the polyisocyanate may be reduced.

Further, the urethane resin may be prepared by using single solution type urethane raw material or double solution type urethane raw material which contains a polyhydroxyl compound and polyisocyanate. An epoxy resin or a melamine resin may be used as a crosslinking agent, if desired.

The polyamide resin is a polyamide obtained via condensation-polymerization of nylon 6,6.6,6.10,6.12,11,12,12.12 and the different monomers of these polyamides. Of these, preferably usable is alcohol-soluble one in view of workability. Examples thereof include those in which the molecular weight of a ternary copolymer or a quaternary copolymer is adjusted; and those in which nylon 6 or nylon 12 is methoxymethylated and dissolved in alcohol or water.

Usable examples of acrylic resins include polyacrylate, polymethylmethacrylate, polymethylethacrylate, those in which the side chain terminal of the foregoing is substituted with a hydroxyalkyl group, the copolymers thereof and so forth.

In order to adjust Young's modulus, Young's modulus may be intended Young's modulus obtained via selection of the Young's modulus of the above-described resins in the preferable range, or via mixture of resins each having a different Young's modulus. Young's modulus itself can also be adjusted by the resin composition, the crosslinking degree, the molecular weight or the like.

Next, a method of preparing a developing roller will be described.

The developing roller possesses a conductive shaft and a coating layer provided on an outer circumference of the conductive shaft, wherein the coating layer contains a resin and surface roughness particles. The coating layer preferably has a volume resistance of 1×10⁴-1×10¹⁰ Ω·cm.

The above-described range is preferable since charge provided to the toner can be stabilized, and excessive charge storage can be inhibited to form stable images even during prolonged use. As a method of adjusting the volume resistance, provided can be a method of adding a conductive material, for example, conductive carbon black, metal powder or the like into the coating layer.

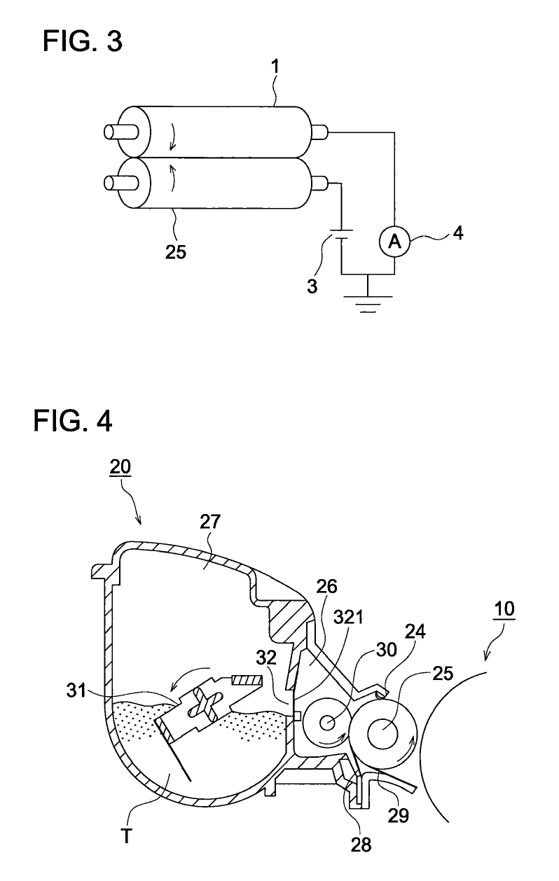

In the present invention, the volume resistance of the coating layer means a value obtained via measurement employing a measuring device shown in FIG. 3.

FIG. 3 is a schematic diagram showing a measuring device of a volume resistance of a coating layer.

In the figure, numeral 1 represents a facing electrode (metal drum), numeral 25 represents a developing roller, numeral 3 represents a direct current power supply, and numeral 4 represents an ammeter.

A voltage of 100 V is applied from direct current power supply 3 while rotating facing electrode 1 and developing roller 25 to be measured in the direction of each arrow, and the current running in this case is measured with ammeter 4 to calculate volume resistance of the coating layer.

Measuring device: A measuring device shown in FIG. 3

Measurement condition: A facing electrode and a developing roller having a linear velocity of 1-5 cm/sec are rotated at constant speed.

Applied voltage: 100 V

Measurement environment: 20° C. and 50% RH

In addition, when forming an upper layer provided on a lower layer, the resin component to be used for formation of the same coating layer as that of the lower layer is usable.

Next, a method of manufacturing a developing roller having a two coating layer structure as an example will be described.

### (Preparation of Lower Layer)

Surface roughness particles are dispersed in a solution in which a resin is dissolved to prepare a coating solution, and this coating solution is coated on the outer circumference of a conductive shaft by an immersion coating method, a spray coating method or the like, followed by drying to form a lower layer.

### (Preparation of Upper Layer)

A coating solution in which a resin is dissolved is coated on the foregoing lower layer by the immersion coating method, the spray coating method or the like, followed by drying to form an upper layer.

A conducting agent, an ion conducting agent or the like as a conductive material can be added into each coating solution, if desired, and the volume resistance can be adjusted by the material and the addition amount.

### <Conducting Agent>

Usable examples of the conducting agent include various conductive metals such as carbon black, graphite, aluminum, copper, tin, stainless steel and so forth, or alloys thereof; various conductive metal oxides such as tin oxide, zinc oxide, indium oxide, titanium oxide, a solid solution of tin oxide and antimony oxide, a solid solution of tin oxide and indium oxide and so forth; and powder of insulating material or the like coated with a conductive material thereof. Of these, carbon black is preferably usable since it is readily available and excellent electrification can be obtained.

Kinds of carbon black are not specifically limited, and usable examples thereof include commonly known carbon blacks such as Ketchen black, channel black, furnace black, and so forth. The mixing amount of carbon black is not specifically limited depending on the kind of carbon black, but the mixing amount is preferably 5-50 parts by weight and more preferably 10-40 parts by weight, based on 100 parts by weight of the resin component. The mixing amount is appropriately arranged to be set in accordance with conductivity and universal hardness desired for the coating layer.

In the case of a carbon black mixing amount of 50 parts by weight or less, conductivity and universal hardness of the developing roller are to be suitable, and evenness of the distribution thereof inside the resin layer is improved, whereby evenness in conductivity is also improved. On the other hand, in the case of a carbon black mixing amount exceeding 5 parts by weight, conductivity at a desired level can be obtained, and further, sufficient percolation of added carbon black becomes possible, whereby conductivity can be stabilized.

### <Ion Conducting Agent>

Any of commonly known inorganic ion salts or organic ion salts may be appropriately selected and employed as an ion conducting agent. Specific examples include Li; alkali metal halides such as LiCl, NaI, NaBr, KI and so forth; perchlorates such as LiClO₄, KClO₄, CuCl₂Mg(ClO₄)₂ and so forth; inorganic ion salts like thiocyanates or the like such as LiSCN, NaSCN, CsSCN and so forth; and organic ion salts such as aliphatic sulfonate, fatty alcohol sulfate, a higher alcohol phosphoric acid ester salt, a higher alcohol ethylene oxide addition sulfuric acid ester salt, a higher alcohol ethylene oxide addition phosphoric acid ester salt, a quaternary ammonium salt, betaine and so forth. Of these, preferably provided can be, specifically, a quaternary ammonium salt such as trimethyl octadecyl ammonium perchlorate, tetramethyl ammonium chloride, benzyl trimethyl ammonium chloride or the like. The ion conducting agent may be used singly or in combination with at least two kinds.

The mixing amount of the ion conducting agent is not specifically limited and is appropriately selected in accordance with each of various situations, but the mixing amount is preferably 0.001-5 parts by weight and more preferably 0.05-2 parts by weight, based on 100 parts by weight of the resin component to form the coating layer.

By the foregoing, obtained is a coating layer exhibiting low positional variation in electrical resistance and low dependence of electrical resistance on voltage, together with low variation in electrical resistance against environmental changes in temperature and humidity, in an electrical resistance range of 1×10⁴-1×10¹⁰ Ω·cm.

Next, nonmagnetic single-component toner of the present invention will be described.

### <<Nonmagnetic Single-Component Toner>>

The nonmagnetic single-component toner of the present invention is not specifically limited as long as it is a toner usable for a heat-fixable nonmagnetic single-component developing device.

The toner preferably has a volume-based median particle diameter D₅₀ of 3-9 μm in view of acquisition of high quality toner images.

As specific examples of resins constituting the toner those generally known as resins employed for the toner are usable, and examples thereof include a polyester resin, a styrene acrylic resin, an epoxy resin and so forth.

All the generally known colorants employed for the toner are usable as colorants. Examples of black colorants include carbon black such as furnace black, channel black, acetylene black, thermal black, lamp black or the like, and magnetic powder such as magnetite powder, ferrite powder or the like.

Examples of the colorant for magenta or red include C.I. pigment red 2, C.I. pigment red 3, C.I. pigment red 5, C.I. pigment red 6, C.I. pigment red 7, C.I. pigment red 15, C.I. pigment red 16, C.I. pigment red 48; 1, C.I. pigment red 53; 1, C.I. pigment red 57; 1, C.I. pigment red 122, C.I. pigment red 123, C.I. pigment red 139, C.I. pigment red 144, C.I. pigment red 149, C.I. pigment red 166. C.I. pigment red 177, C.I. pigment red 178, C.I. pigment red 222 and so forth.

Further, examples of the colorant for yellow include C.I. pigment orange 31, C.I. pigment orange 43, C.I. pigment yellow 12, C.I. pigment yellow 13, C.I. pigment yellow 14, C.I. pigment yellow 15, C.I. pigment yellow 74, C.I. pigment yellow 93, C.I. pigment yellow 94, C.I. pigment yellow 138, C.I. pigment yellow 150, C.I. pigment yellow 155, C.I. pigment yellow 180, C.I. pigment yellow 185 and so forth.

Further, examples of the pigment for cyan include C.I. pigment blue 15, C.I. pigment blue 15:2, C.I. pigment blue 15:3, C.I. pigment blue 15:4, C.I. pigment blue 16, C.I. pigment blue 60, C.I. pigment blue 62, C.I. pigment blue 66 and so forth.

The external additive is attached onto the surface of the nonmagnetic single-component toner of the present invention. The external additive is not specifically limited as long as electrification and fluidity of the nonmagnetic single-component toner can be fallen within the preferable range, and usable examples thereof include commonly known inorganic particles and organic particles.

Commonly known particles are usable as inorganic particles, and preferable examples thereof include silica particles, titania particles, alumina particles, strontium titanate particles and so forth. Further, these inorganic particles having been subjected to a hydrohobization treatment are also usable, if desired.

Examples of commercially available silica particles include R-805, R-976, R-974, R-972, R-812 and R-809, produced by Nihon Aerosil Co., Ltd.; HVK-2150 and H-200, produced by Hoechst company; TS-720, TS-530, TS-610, H-5 and MS-5, produced by Cabot company; and so forth.

Examples of commercially available titania particles include T-805 and T-604, produced by Nihon Aerosil Co., Ltd.; MT-100S, MT-100B, MT-500BS, MT-600, MT-600SS and JA-1, produced by TAYCA Corp.; TA-300SI, TA-500, TAF-130, TAF-510 and TAF-510T, produced by Fuji titanium Industry Co., Ltd.; IT-S, IT-OA, IT-OB and IT-OC produced by Idemitsu Kosan Co., Ltd.; and so forth.

Examples of commercially available alumina particles include RFY-C and C-604, produced by Nihon Aerosil Co., Ltd.; TTO-55 produced by ISHIHARA SANGYO KAISHA, LTD.; and so forth.

Further, spherical organic particles having a number average primary particle diameter of approximately 10-2000 nm are preferably usable as organic particles. A homopolymer such as styrene, methyl methacrylate or the like and a copolymer of these are specifically usable.

A lubricant is also possible to be used in order to further improve cleaning ability and transferability, and the following metal salts of higher fatty acid can be exemplified. That is, specific examples thereof include a salt of zinc of a stearic acid, a salt of aluminum of a stearic acid, a salt of copper of a stearic acid, a salt of magnesium of a stearic acid, a salt of calcium of a stearic acid, or the like; a salt of zinc of an oleic acid, a salt of manganese of an oleic acid, a salt of iron of an oleic acid, a salt of copper of an oleic acid, a salt of magnesium of an oleic acid or the like; a salt of zinc of a palmitic acid, a salt of copper of a palmitic acid, a salt of magnesium of a palmitic acid, a salt of calcium of a palmitic acid or the like; a salt of zinc of a linoleic acid, a salt of calcium of a linoleic acid or the like; and a salt of zinc of a recinoleic acid, a salt of calcium of a recinoleic acid or the like.

The addition amount of the external additive and/or the lubricant is preferably 0.1-10.0% by weight, based on the total weight of toner. In addition, as an addition method of the external additive or lubricant, provided is a method employing each of commonly known various mixers such as a tabular mixer, a Henschel mixer, a nauter mixer and a V-shaped mixer and so forth.

A method of manufacturing the toner is not limited, but external additives are attached onto the surface of toner base material prepared by a commonly known polymerization method or a pulverization method to prepare the toner.

Volume-based median particle diameter D₅₀ can be measured and calculated employing an apparatus in which a computer system (manufactured by Beckman Coulter Inc.) for data processing is connected to “Multisizer 3” (manufactured by Beckman-Coulter Inc.).

As for procedures of measuring volume-based median particle diameter D₅₀, after 20 ml of the surfactant solution (surfactant solution in which a neutral detergent containing a surfactant is diluted with pure water by 10 times) is mixed with 0.02 g of toner, the mixture was subjected to an ultrasonic dispersion for one minute to prepare a toner dispersion. This toner dispersion is then poured, using a pipette, in a beaker containing ISOTON II (produced by Beckman Coulter Inc.) placed in a sample stand, until the measured content reaches 5-10% by weight, and a counter is set to 30000 counts to be measured. In addition, Multisizer 3 having an aperture diameter of 50 μm is used.

Next, a developing device of the present invention will be described.

### <<Developing Device>>

A developing roller of the present invention is installed in an image forming apparatus equipped with a developing device to visualize an electrostatic latent image, after a nonmagnetic single-component toner thin layer is formed on the surface of the developing roller by carrying the nonmagnetic single-component toner, and the nonmagnetic single-component toner is attached to the electrostatic latent image on the photoreceptor surface from the foregoing thin layer without being brought into contact with the photoreceptor in this situation.

FIG. 4 is a cross-sectional schematic view showing an example of a developing device of the present invention.

Developing device 20 in FIG. 4 possesses a buffer chamber 26 adjacent to developing roller 25 and hopper 27 adjacent to buffer chamber 26.

Regulation blade 28 as a toner regulation member is arranged to be placed in buffer chamber 26 in a situation where it is brought into pressure contact with developing roller 25. Regulation blade 28 controls the charge amount and the adhesion amount of toner on developing roller 25. On the downstream side of regulation blade 28 with respect to the direction of rotation of developing roller 25, it is also possible to place auxiliary blade 29 to assist regulation of the charge amount and the adhesion amount of toner on developing roller 25.

Developing roller 25 is pressed onto supply roller 30. Supply roller 30 is rotated and driven in the same direction as that of developing roller 25 (in the direction of anticlockwise rotation in the figure) by a motor unshown in the figure. Supply roller 30 possesses a conductive cylindrical substrate and a foam layer formed from polyurethane foam or the like provided on the outer circumference of the substrate.

Toner T as a non-magnetic single-component toner is stored in hopper 27. Hopper 27 is equipped with rotating body 31 to agitate toner T. Rotating body 31 is fitted with film-shaped conveyance blades, and toner T is conveyed via rotation of rotating body 31 in the direction of the arrow. Toner T conveyed by the conveyance blades is supplied to buffer chamber 26 via path 32 provided at a partition wall to separate hopper 27 from buffer chamber 26. In addition, the conveyance blade bows in shape in front of the rotating direction of the blade via rotation of rotating body 31 while conveying toner T, and also restores it to its former straight shape when it reaches the left side end of path 32. In this case, the blade is designed to be restored to its original straight shape through the bowed state to supply toner T into path 32.

In developing device 20, developing roller 25 is driven in the direction of the arrow during image formation, and the toner in buffer chamber 26 is supplied onto developing roller 25 via rotation of supply roller 30. Toner T supplied onto developing roller 25 is charged and layered employing regulation blade 28 and auxiliary blade 29, and subsequently conveyed to the region facing photoreceptor 10 which is not brought into contact with the developing roller to develop an electrostatic latent image on the photoreceptor. After electrification is removed by electrification removal blade 24 via rotation of developing roller 25, and electrostatic attachment force between the developing roller and the toner is reduced, the toner which is not used for the development is subsequently collected from developing roller 25 by supply roller 30.

In addition, the developing roller is preferably placed at a distance of 50-500 mm from the photoreceptor surface in order to avoid generation of scratches caused by the photoreceptor brought into contact with the developing roller, and to obtain high-quality color images.

### <<Regulation Blade>>

The regulation blade of the present invention (regulation member) is an elastic blade, roller or the like, and is preferably made of a frictional electrification type material suitably to give a predetermined polarity to the toner.

In the present invention, preferable materials are a metal plate such as SUS, phosphor bronze or the like, silicone rubber, urethane rubber, styrene-butadiene rubber and so forth. Further, provided may be an organic resin layer made of polyamide, polyimide, nylon, melamine, melamine cross-linked nylon, a phenol resin, a fluorine based resin, a silicone resin, a polyester resin, a urethane resin or a styrene based resin. Further, it is preferable to use conductive rubber, conductive resin and so forth, or to disperse a filler or a charge control agent such as metal oxide, carbon black, inorganic whisker or inorganic fiber in rubber or a resin of the regulation blade in order to provide a suitable dielectric property or charge providing property appropriately to charge the toner.

The contact pressure between the regulation blade and the developing roller is preferably 3-250 N/m, and more preferably 5-30 N/m as a linear pressure in the sleeve base line direction. In the case of a contact pressure of 3-250 N/m, the conveyance amount of toner is specified, and the electrification amount of toner becomes sharp, whereby generation of fog and scattering of toner can be inhibited.

Next, a full color image forming apparatus equipped with a developing device of the present invention will be described.

<<Image Formation>>

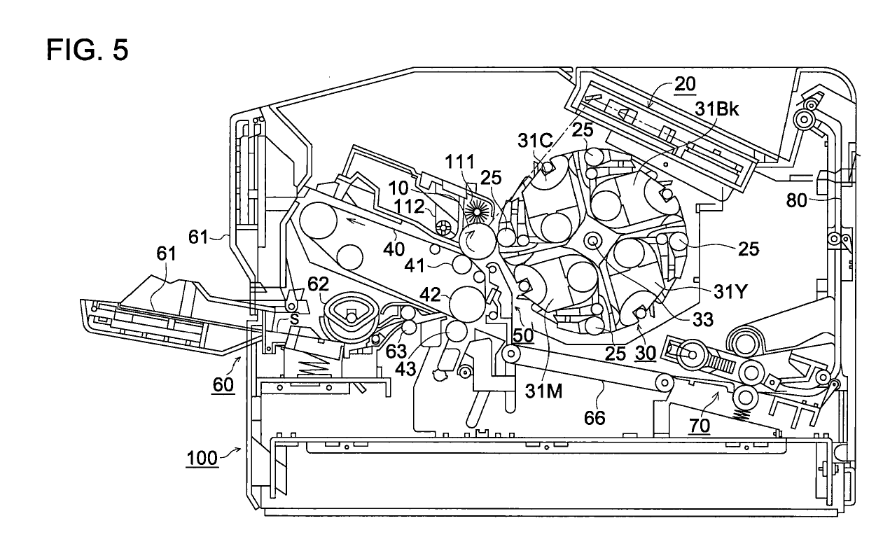

FIG. 5 is a schematic cross-sectional view showing an example of a full color image forming apparatus.

In the full color image forming apparatus shown in FIG. 51 charging brush 111 for uniformly charging the surface of photoreceptor drum 10 at a given potential, and cleaner 112 for scraping the toner remaining on photoreceptor drum 10 are arranged around photoreceptor 10.

Moreover, laser scanning optical system 20 for exposing photoreceptor 10 charged by charging brush 111 to a laser beam is provided. Laser scanning optical system 20 is a known system including a laser diode, a polygon mirror and an fθ optical element, and cyan, magenta, yellow and black data to be printed are transferred from a host computer to the controlling means thereof. Laser scanning optical system 20 successively outputs laser beams according to the data of each of the above colors obtained via scanning exposure to photoreceptor drum 10 for successively forming electrostatic latent images on photoreceptor drum 10.

Developing apparatus 30 for supplying each of the color toners to photoreceptor drum 10 to perform full color development is constituted by four developing devices 31Y, 31M, 31C and 31Bk each containing a yellow, magenta, cyan and black non-magnetic single component toners, respectively, which are arranged around supporting axis 33. The developing devices can be rotated around supporting axis 33 so that each of developing devices 31Y, 31M, 31C and 31Bk is successively introduced at a position facing to photoreceptor drum 10.

In each of developing devices 31Y, 31M, 31C and 31Bk of full color developing apparatus 30, the toner regulation member is contacted by pressure to developer carrier 25 (developing roller) to convey toner by rotation, as shown in FIG. 4. The amount of toner conveyed by developing roller 25 is regulated by this toner regulation member and the conveyed toner is charged at the same time. In addition, in full color developing apparatus 30, two toner regulation members may be provided in order to suitably perform the regulation and charge the toner conveyed by the developing roller.

Full color developing apparatus 30 is rotated around supporting axis 33 every time the electrostatic latent image of each color is formed, so that developing devices 31Y, 31M, 31C and 31Bk each containing the corresponding color toner are successively introduced to the position where the developing device is faced to photoreceptor drum 10. And then each of the color toners is successively supplied onto the electrostatic latent image successively formed on photoreceptor drum 10 via no contact with developing roller 25 contained in each of developing devices 31Y, 31M, 31C and 31Bk to conduct the development.

Endless intermediate transfer belt 40 is provided at the lower course from full color developing apparatus 30 in the rotating direction of photoreceptor drum 10. Intermediate transfer belt 40 is driven to synchronously rotate with photoreceptor drum 10. Intermediate transfer belt 40 is contacted with photoreceptor drum 10 by pressing with rotatable primary transfer roller 41, and rotatable secondary transfer roller 43 is provided to face to support roller 42 supporting intermediate transfer belt 40. Recording material S such as recording paper is pressed to intermediate transfer roller 40 by secondary transfer roller 43.

Cleaner 50 for scraping off the toner remaining on intermediate belt 40 is provided in the space between full color developing apparatus 30 and intermediate transfer belt 40, so that cleaner 50 can be contacted to and released from intermediate transfer belt 40.

Paper supplying means 60 for introducing recording material S such as conventional recording paper into intermediate transfer belt 40 is composed of paper supplying tray 61 for storing recording material S, paper supplying roller 62 for supplying one by one recording material S stored in paper supplying tray 61 and timing roller 63 for sending recording material S between intermediate belt 40 and secondary transfer roller 43, supplied synchronously with the image formed on intermediate transfer belt 40. The recording material conveyed between intermediate transfer belt 40 and secondary transfer roller 43 is pressed against intermediate transfer belt 40 by secondary transfer roller 43, so that the toner image is transferred by press onto recording material S.

Recording material S on which the toner image is transferred by press is introduced into fixing device 70 with conveying means 66 composed of an air suction belt. The toner image transferred onto recording material S is fixed in fixing device 70, and then recording material S is take out onto the upper face of image forming apparatus 100 through vertical conveying pass 80.

Next, the operation to conduct full color image formation employing this full color image forming apparatus will be described in detail.

Photoreceptor drum 10 and intermediate transfer belt 40 are rotated at the same circumferential speed in each of their directions and photoreceptor drum 10 is charged to a designated potential by charging brush 11.

An electrostatic latent image of a yellow image is formed via exposure of charged photoreceptor drum 10 according to the yellow image data by laser scanning optical system 20. And then a yellow image is developed by supplying a charged yellow toner onto photoreceptor drum 10 from developing device 31Y containing the yellow toner through the foregoing toner regulation members. The yellow toner image formed on photoreceptor drum 10 is primarily transferred onto intermediate transfer belt 40 by contacting intermediate transfer belt 40 by press to photoreceptor drum 10 with the primary transfer roller 41.

After the transfer of the yellow toner image onto intermediate transfer belt 40, full color developing apparatus 30 is rotated around supporting axis 33 for introducing developing device 31M containing magenta toner into the position facing to photoreceptor drum 10. And then the magenta image is exposed to laser scanning optical system 20 on charged photoreceptor drum 10 to form an electrostatic latent image in the same manner as in the yellow image formation. The electrostatic image is developed by the developing device 31M containing the magenta toner, and the developed magenta toner image is primarily transferred onto intermediate transfer belt 40 from the photoreceptor drum 10. Furthermore, exposure, development and primarily transfer of a cyan image and black image are successively performed, so that a full color toner image is formed by successively piling the yellow, magenta, cyan and black images on intermediate transfer belt 40.

After primarily transferring the last black image onto intermediate transfer belt 40, recording material S is conveyed with timing roller 63 between secondary transfer roller 43 and intermediate transfer belt 40, and the full color toner image formed on intermediate transfer belt 40 is secondarily transferred onto recording material S by pressing recording material S against intermediate transfer belt 40 with secondary transfer roller 43.

After secondarily transferring the full color toner image onto recording material S, recording material S is introduced into fixing device 70 by conveying means 66. The toner image transferred onto recording material S is fixed by fixing device 70, and then recording material S is taken out onto the upper surface of apparatus main body 100 through vertical conveying pass 80.

### EXAMPLE

Next, the present invention will be described referring to examples, but embodiments in the present invention are not limited thereto.

### <<Preparation of Conductive Shaft>>

A conductive shaft in the form of a hollow cylinder, which is made of SUS 303, was prepared as a conductive shaft for a developing roller. This is designated as “shaft 1”.

### <Preparation of Surface Roughness Particle>

The following particles were prepared as surface roughness resin particles.

### (Surface Roughness Particle 1)

Polyethylene resin particle (a particle diameter of 3 μm)

### (Surface Roughness Particle 2)

Polyethylene resin particle (a particle diameter of 5 μm)

### (Surface Roughness Particle 3)

Polyethylene resin particle (a particle diameter of 15 μm)

### (Surface Roughness Particle 4)

Polyethylene resin particle (a particle diameter of 30 μm)

### (Surface Roughness Particle 5)

Polyethylene resin particle (a particle diameter of 50

### (Surface Roughness Particle 6)

Polyurethane resin particle (a particle diameter of 5 μm

### (Surface Roughness Particle 7)

Polyurethane resin particle (a particle diameter of 15 μm)

### (Surface Roughness Particle 8)

Polyurethane resin particle (a particle diameter of 30 μm)

### (Surface Roughness Particle 9)

Crosslinked acrylic resin particle (a particle diameter of 15 μm)

### (Surface Roughness Particle 10)

Crosslinked acrylic resin particle prepared by firmly attaching silica particles on its surface (a particle diameter of 15 μm)

In addition, the above-described particle diameters each represent a volume-based median particle diameter D₅₀.

### <<Preparation of Developing Roller>>

### <Preparation of Developing Roller 1>

In a solution in which 100 parts by weight of a polyester resin was dissolved in 500 parts by weight of tetrahydrofuran, for 2 hours, dispersed were 20 parts by weight of carbon black “Ketchen black EC300J” produced by Lion Corporation and 20 parts by weight of “surface roughness particle 1” composed of polyethylene resin particles employing a sand mill to prepare a lower layer formation coating solution. This is designated as “lower layer formation coating solution 1”.

After spray-coating “lower layer formation coating solution 1” on the outer circumference of “shaft 1”, the resulting was dried at 120° C. for one hour, and “lower layer 1” having a dry layer thickness of 10 μm was formed to prepare “developing roller 1”.

### <Preparation of Developing Rollers 2-8>

“Developing rollers 2-8” were prepared similarly to preparation of “developing roller 1”, except that “surface roughness particle 1” made of a polyethylene resin in the preparation of “developing roller 1” was replaced by each of the corresponding surface roughness particles described in Table 1.

### <Preparation of Developing Roller 9>

In a solution in which 100 parts by weight of a polyester resin was dissolved in 500 parts by weight of ethanol, for 2 hours, dispersed were 20 parts by weight of carbon black “Ketchen black EC300J” produced by Lion Corporation and 20 parts by weight of “surface roughness particle 8” composed of polyurethane resin particles employing a sand mill to prepare a lower layer formation coating solution. This is designated as “lower layer formation coating solution 9”.

After spray-coating “lower layer formation coating solution 9” on the outer circumference of “shaft 1”, the resulting was dried at 120° C. for one hour, and “lower layer 9” having a dry layer thickness of 10 μm was formed.

### (Formation of Upper Layer)

In a solution in which 100 parts by weight of a polyester resin was dissolved in 500 parts by weight of ethanol, for 2 hours, dispersed were 20 parts by weight of carbon black “Ketchen black EC300J” produced by Lion Corporation and 0.001 parts by weight of trimethyloctadecylammonium perchlorate employing a sand mill to prepare a upper layer formation coating solution. This is designated as “upper layer formation coating solution 9”.

After spray-coating “upper layer formation coating solution 9” on the outer circumference of “lower layer 9”, the resulting was dried at 120° C. for one hour, and “upper layer 9” having a dry layer thickness of 5 μm was formed to prepare “developing roller 9”.

### <Preparation of Developing Roller 10>

In a solution in which 100 parts by weight of a polyurethane resin was dissolved in 500 parts by weight of ethanol, for 2 hours, dispersed were 20 parts by weight of carbon black “Ketchen black EC300J” produced by Lion Corporation and 20 parts by weight of “surface roughness particle 7” composed of polyurethane resin particles employing a sand mill to prepare a lower layer formation coating solution. This is designated as “lower layer formation coating solution 10”.

After spray-coating “lower layer formation coating solution 10” on the outer circumference of “shaft 1”, the resulting was dried at 120° C. for one hour, and “lower layer 10” having a dry layer thickness of 10 μm was formed.

### (Formation of Upper Layer)

In a solution in which 100 parts by weight of a polyurethane resin was dissolved in 500 parts by weight of ethanol, for 2 hours, dispersed were 20 parts by weight of carbon black “Ketchen black EC300J” produced by Lion Corporation and 0.001 parts by weight of trimethyloctadecylammonium perchlorate employing a sand mill to prepare a upper layer formation coating solution. This is designated as “upper layer formation coating solution 10”.

After spray-coating “upper layer formation coating solution 10” on the outer circumference of “lower layer 10”, the resulting was dried at 120° C. for one hour, and “upper layer 10” having a dry layer thickness of 5 μm was formed to prepare “developing roller 10”.

### <Preparation of Developing Roller 11>

In a solution in which 100 parts by weight of a polyurethane resin as thermoplastic elastomer was dissolved in 500 parts by weight of methylethyl ketone, for 2 hours, dispersed were 20 parts by weight of carbon black “Ketchen black EC300J” produced by Lion Corporation, 0.001 parts by weight of trimethyloctadecylammonium perchlorate and 20 parts by weight of “surface roughness particle 7” composed of polyurethane resin particles employing a sand mill to prepare a lower layer formation coating solution. This is designated as “lower layer formation coating solution 11”.

After spray-coating “lower layer formation coating solution 11” on the outer circumference of “shaft 1”, the resulting was dried at 120° C. for one hour, and “lower layer 11” having a dry layer thickness of 10 μm was formed to prepare “developing roller 11”.

### <Preparation of Developing Roller 12>

“Developing roller 12” was prepared similarly to preparation of “developing roller 11”, except that “surface roughness particle 7” composed of polyurethane resin particles in the preparation of “developing roller 11” was replaced by “surface roughness particle 9” composed of crosslinked acrylic resin particles.

### <Preparation of Developing Roller 13>

“Developing roller 13” was prepared similarly to preparation of “developing roller 11”, except that “surface roughness particle 7” composed of polyurethane resin particles in the preparation of “developing roller 11” was replaced by “surface roughness particle 10” made of a crosslinked acrylic resin which was formed by attaching silica particles onto its surface to prepare “developing roller 13”.

### <Preparation of Developing Roller 14>

In a solution in which 100 parts by weight of a polyamide resin was dissolved in 500 parts by weight of ethanol, for 2 hours, dispersed were 20 parts by weight of carbon black “Ketchen black EC300J” produced by Lion Corporation and 20 parts by weight of “surface roughness particle 9” composed of crosslinked acrylic resin particles employing a sand mill to prepare a lower layer formation coating solution. This is designated as “lower layer formation coating solution 14”.

After spray-coating “lower layer formation coating solution 14” on the outer circumference of “shaft 1”, the resulting was dried at 120° C. for one hour, and “lower layer 14” having a dry layer thickness of 10 μm was formed to prepare “developing roller 14”.

### <Preparation of Developing Roller 15>

In a solution in which 100 parts by weight of an ethylene-vinyl acetate copolymer resin was dissolved in 500 parts by weight of methylethyl ketone, for 2 hours, dispersed were 20 parts by weight of carbon black “Ketchen black EC300J” produced by Lion Corporation, 0.001 parts by weight of trimethyloctadecylammonium perchlorate and 20 parts by weight of “surface roughness particle 9” composed of crosslinked acrylic resin particles employing a sand mill to prepare a lower layer formation coating solution. This is designated as “lower layer formation coating solution 15”.

After spray-coating “lower layer formation coating solution 15” on the outer circumference of “shaft 1”, the resulting was dried at 120° C. for one hour, and “lower layer 15” having a dry layer thickness of 10 μm was formed to prepare “developing roller 15”.

### <Preparation of Developing Roller 16>

“Developing roller 16” was prepared similarly to preparation of “developing roller 15”, except that “surface roughness particle 9” composed of crosslinked acrylic resin particles in the preparation of “developing roller 15” was replaced by “surface roughness particle 3” composed of polyethylene resin particles having a particle diameter of 15 μm to prepare “developing roller 16”.

The layer structure of developing rollers, kinds of resins employed for formation of coating layers, kinds and particle diameters of surface roughness particles, surface roughness Ra and Young's modulus Y are shown in Table 1.

TABLE 1

| | | Lower layer | | | | |
|---|---|---|---|---|---|---|
| Devel- | | | Surface | | Surface | |
| oping | | | roughness | Upper | roughness | Young's |
| roller | Layer | | particle | layer | Ra | modulus |
| No. | structure | Resin | No. | Resin | (μm) | Y (MPa) |
| 1 | Single | *1 | 1 | — | 0.3 | 170 |
| | layer | | | | | |
| 2 | Single | *1 | 2 | — | 0.5 | 170 |
| | layer | | | | | |
| 3 | Single | *1 | 3 | — | 1.5 | 170 |
| | layer | | | | | |
| 4 | Single | *1 | 4 | — | 2.5 | 170 |
| | layer | | | | | |
| 5 | Single | *1 | 5 | — | 2.8 | 170 |
| | layer | | | | | |
| 6 | Single | *1 | 6 | — | 0.6 | 150 |
| | layer | | | | | |
| 7 | Single | *1 | 7 | — | 1.5 | 150 |
| | layer | | | | | |
| 8 | Single | *1 | 8 | — | 2.5 | 150 |
| | layer | | | | | |
| 9 | Double | *1 | 8 | *1 | 1.7 | 50 |
| | layers | | | | | |
| 10 | Double | *2 | 7 | *2 | 1.5 | 1 |
| | layers | | | | | |
| 11 | Single | *2 | 7 | — | 1.5 | 150 |
| | layer | | | | | |
| 12 | Single | *2 | 9 | — | 1.5 | 600 |
| | layer | | | | | |
| 13 | Single | *2 | 10 | — | 1.8 | 1000 |
| | layer | | | | | |
| 14 | Single | *3 | 9 | — | 1.5 | 1200 |
| | layer | | | | | |
| 15 | Single | *4 | 9 | — | 1.5 | 320 |
| | layer | | | | | |
| 16 | Single | *4 | 3 | — | 1.5 | 200 |
| | layer | | | | | |

*1: Polyester,
*2: Polyurethane,
*3: Polyamide, and
*4: ethylene-vinyl acetate copolymer

In addition, surface roughness Ra and Young's modulus Y in the figure are measured by the foregoing method.

### <<Evaluation>>

As to the evaluation of developing rollers, the resulting developing rollers described above were installed in a color laser printer “Magicolor 2430DL” (Manufactured by Konica Minolta Business Technologies, Inc.) in order, and 5000 sheets for each of the developing rollers were printed at high temperature and high humidity (at 30° C. and 80% RH) as well as at low temperature and low humidity (at 10° C. and 20% RH).

As to the initial performance evaluation of the developing roller, 10 sheets of A4 size document were printed with a pixel ratio of 40% (a full color image having 10% each of yellow, magenta, cyan and black) to be evaluated in image density.

Subsequently, 5000 sheets were printed in intermittent mode pausing for 5 seconds every sheet employing a document sheet at a pixel ratio of 20% (a full color image having 5% each of yellow, magenta, cyan and black).

As to the performance evaluation after completing 5000 print sheets, 10 A4 size document sheets were printed at a pixel ratio of 20% (a full color image having 5% each of yellow, magenta, cyan and black) similarly to the case of the initial performance evaluation to evaluate image density, fog and contamination inside the apparatus (toner leakage).

### <Image Density>

To determine image density, the densities at the solid black image portion at the initial stage of printing and after completing 5000 print sheets were measured at 12 points employing a Macbeth reflection densitometer “RD-918” to be evaluated in mean reflection density. In addition, density measurement was conducted employing a Macbeth reflection densitometer “RD-918”, and evaluation was made in relative reflection density when reflection density of a paper sheet was set to “0”.

Incidentally, an image density of 1.30 or more is practically acceptable with no problem.<Fog>

White paper sheet reflection density was measured after completing 5000 print sheets to evaluate fog in relative reflection density when reflection density of a paper sheet itself was set to “0”.

The white paper sheet reflection density in A4 size was measured at 20 portions, and the mean value was designated as white paper density.

In addition, density measurement was conducted employing a Macbeth reflection densitometer “RD-918”. A fog density of 0.005 or less is practically acceptable with no problem.

### <Contamination Inside Apparatus (Toner Leakage)>

After completing 5000 print sheets, the peripheral area of a developing apparatus was visually observed to evaluate contamination inside the apparatus via visual observation of toner leakage around the developing apparatus. Incidentally, the contamination inside the apparatus evaluated as A or B is acceptable.

### Evaluation Criteria

A: No toner leakage is observed, which is acceptable.

B: Toner leakage is slightly observed, but no practical problem is produced.

C: Toner leakage is clearly observed, and a practical problem is produced.

Evaluation results are shown in Table 2.

TABLE 2

| | | At initial | | | |
|---|---|---|---|---|---|
| | | stage of | After 5000^{th} print | | |
| | Developing | printing | | | Contamination |
| | roller | Image | Image | | inside |
| | No. | density | density | Fog | apparatus |
| Example 1 | 2 | 1.36 | 1.31 | 0.004 | B |
| Example 2 | 3 | 1.44 | 1.41 | 0.001 | A |
| Example 3 | 4 | 1.37 | 1.31 | 0.002 | B |
| Example 4 | 7 | 1.38 | 1.32 | 0.003 | B |
| Example 5 | 11 | 1.32 | 1.30 | 0.003 | B |
| Example 6 | 6 | 1.32 | 1.30 | 0.003 | A |
| Example 7 | 8 | 1.32 | 1.30 | 0.001 | A |
| Example 8 | 9 | 1.47 | 1.42 | 0.001 | A |
| Example 9 | 10 | 1.41 | 1.38 | 0.002 | B |
| Example 10 | 16 | 1.32 | 1.30 | 0.002 | B |
| Comparative | 1 | 1.22 | 1.14 | 0.012 | C |
| Example 1 | | | | | |
| Comparative | 5 | 1.45 | 1.28 | 0.012 | C |
| Example 2 | | | | | |
| Comparative | 14 | 1.32 | 1.22 | 0.015 | C |
| Example 3 | | | | | |
| Comparative | 15 | 1.43 | 1.13 | 0.012 | C |
| Example 4 | | | | | |
| Comparative | 12 | 1.42 | 1.22 | 0.012 | C |
| Example 5 | | | | | |
| Comparative | 13 | 1.38 | 1.32 | 0.010 | C |
| Example 6 | | | | | |

As is clear from Table 2, it is confirmed that excellent results are obtained in all the evaluation items in Examples 1-10, resulting in producing of the effects of the present invention. In contrast, it is confirmed that no satisfactory results are obtained in some of the evaluation items in Comparative examples 1-6, resulting in no generation of the effects of the present invention.

### EFFECT OF THE INVENTION

The developing roller of the present invention, which is installed in a non-contact single-component developing system image forming apparatus, produces the effect by which neither fog nor contamination inside the apparatus is generated, and no insufficient image density is produced, even though printing a large number of paper sheets (5000 paper sheets, for example).

What is claimed is:

1. A developing roller comprising a conductive shaft and a coating layer provided on an outer circumference of the conductive shaft,
wherein the coating layer comprises a resin and a surface roughness particle, and the coating layer surface has a surface roughness Ra of 0.5-2.5 μm and a Young's modulus Y of 1-200 MPa.

2. The developing roller of claim 1, comprising a double-layered structure having an upper layer comprising a resin, and a lower layer comprising a resin and a surface roughness particle, provided that the lower layer is located at a nearer position to the conductive shaft than the upper layer.

3. The developing roller of claim 1,
wherein the surface roughness particle has a volume-based average median particle diameter D₅₀ of 5-30 μm.

4. The developing roller of claim 1,
wherein the surface roughness particle has a volume-based average median particle diameter D₅₀ of 7-20 μm.

5. The developing roller of claim 1,
wherein the surface roughness particle comprises a resin particle.

6. The developing roller of claim 1,
wherein the coating layer surface has a surface roughness Ra of 0.7-2.0 μm.

7. The developing roller of claim 1,
wherein the coating layer surface has a Young's modulus Y of 2-170 MPa.

8. The developing roller of claim 1,
wherein the coating layer surface has a Young's modulus Y of 140-170 MPa.
